(19) United States
(12) Patent Application Publication
(10) Pub. No.: US 2016/0232714 A1
(43) Pub. Date: Aug. 11, 2016

(54) APPARATUS, METHOD AND SYSTEM FOR PROVIDING INTERACTIVE MULTIMEDIA CONTENT BASED ON PRINT MEDIA

(71) Applicant: Liberty Procurement Co. Inc., Union, NJ (US)

(72) Inventors: Kerry McGuire, Union, NJ (US); Nathan Longbrook, Union, NJ (US); Jesse Haynes, Union, NJ (US); Jitendra Kommireddy, Union, NJ (US); Peddi Kanumuri, Union, NJ (US); Audrey Stavish, Union, NJ (US); Hilary Kaczka, Union, NJ (US); Shelly Dooley, Union, NJ (US); Elizabeth Seitz, Union, NJ (US)

(73) Assignee: Liberty Procurement Co. Inc., Union, NJ (US)

(21) Appl. No.: 15/016,465

(22) Filed: Feb. 5, 2016

Related U.S. Application Data
(60) Provisional application No. 62/113,008, filed on Feb. 6, 2015.

(51) Int. Cl. G06T 19/00; G06T 7/00; G06T 19/20; G06T 1/00

(52) U.S. Cl. CPC G06T 19/006; G06T 1/0007; G06T 7/0081; G06T 19/20; G06T 2200/04; G06T 2200/24; G06T 2219/2016

(57) ABSTRACT

Aspects of the disclosure relate to an image processing method performed at a wireless communication device. The method includes receiving, using one or more processors, an image captured by the wireless communication device from print media. An image of a target item may be detected from the captured image. The detected image may correspond to a portion of the captured image that being displayed at a display device associated with the wireless communication device. Using the one or more processors, a related image having a plurality of image portions retrieved from a database may be prepared for display. The plurality of image portions is related to the detected image of the target item. One or more controls associated with the display device are provided. The controls may be configured to receive command information indicating that at least part of the related image may be used for an interactive session.

### CROSS-REFERENCE TO RELATED APPLICATIONS

The present application claims the benefit of the filing date of U.S. Provisional Patent Application No. 62/113,008, filed Feb. 6, 2015, the disclosure of which is hereby incorporated herein by reference.

### BACKGROUND

The benefits of print media, such as printed catalogs, are significant. For instance, printed catalogs are mailed to millions of potential customers with direct marketing of certain advertised items. For many reasons, people enjoy and are comfortable working with print media. Recently, some forms of print media have included certain type of electronic tags or print codes configured for use with specialized devices. Typically, the devices can be adapted to detect the presence of the electronic tags/print codes when the media is brought within a certain range. However, the print media generally needs to be specifically designed and configured for use with the specialized devices leading to increases in printing cost, and often these devices are limited to text-based one-way communications.

### BRIEF SUMMARY

Aspects of the present disclosure are advantageous for providing an image processing method performed at a wireless communication device. The method includes receiving, using one or more processors, an image captured by the wireless communication device from print media. An image of a target item may be detected from the captured image. The detected image may correspond to a portion of the captured image being displayed at a display device associated with the wireless communication device. Using the one or more processors, a related image having a plurality of image portions retrieved from a database may be prepared for display. The plurality of image portions may be related to the detected image of the target item. One or more controls associated with the display device are provided. The one or more controls for receiving command information indicating at least part of the related image for an interactive session.

In one example, the image is captured at a device having wireless communication capability and including the display device. The related image may include image portions depicting a 3D image of the target item and a 360 degree view of the target item. In this regard, the interactive session includes rotating the 360 degree view of the target item between a first degree view and a second degree view.

In another example, the interactive session includes simulating an operation of the target item. In that regard, simulating an operation of the target item is operable by touching an area of the display device.

In yet another example, the related image includes image portions depicting different versions of the target item for scrollable display. In this example, the interactive session includes scrolling the images of the different versions of the target item to display a predetermined version of the target item.

In another aspect, a non-transitory computer readable medium is provided. The non-transitory computer readable medium may be configured to store instructions that, when executed by one or more processors, cause the one or more processors to perform image processing method at a wireless communication device. The method includes receiving, using one or more processors, an image captured by the wireless communication device from print media. An image of a target item may be detected from the captured image. The detected image may correspond to a portion of the captured image being displayed at a display device associated with the wireless communication device. Using the one or more processors, a related image having a plurality of image portions retrieved from a database may be prepared for display. The plurality of image portions may be related to the detected image of the target item. One or more controls associated with the display device are provided. The one or more controls for receiving command information indicating at least part of the related image for an interactive session.

In yet another aspect, an image processing system of a wireless communication device is provided. The system includes a memory storing a plurality of images and one or more processors in communication with the memory. The one or more processors are configured to receive an image captured by the wireless communication device from print media. An image of a target item may be detected from the captured image. The detected image may correspond to a portion of the captured image being displayed at a display device associated with the wireless communication device. A related image having a plurality of image portions retrieved from a database may be prepared for display. The plurality of image portions may be related to the detected image of the target item. One or more controls associated with the display device are provided. The one or more controls for receiving command information indicating at least part of the related image for an interactive session.

### BRIEF DESCRIPTION OF THE DRAWINGS

FIG. 1 is an example of an image capture process in accordance with aspects of the disclosure.

FIG. 2 is a pictorial diagram of a system in accordance with aspects of the disclosure.

FIG. 3 is a block diagram of a system in accordance with aspects of the disclosure.

FIG. 4 is an example of an interactive session in accordance with aspects of the disclosure.

FIGS. 5A-5B are another example of an interactive session in accordance with aspects of the disclosure.

FIGS. 6A-6C are yet another example of an interactive session in accordance with aspects of the disclosure.

FIG. 7 is an example of a flow diagram in accordance with aspects of the disclosure.

FIG. 8 is another example of an interactive session in accordance with aspects of the disclosure.

FIG. 9 is another example of an interactive session in accordance with aspects of the disclosure.

FIG. 10 is another example of an interactive session in accordance with aspects of the disclosure.

FIG. 11 is another example of an interactive session in accordance with aspects of the disclosure.

FIG. 12 is another example of an interactive session in accordance with aspects of the disclosure.

FIG. 13 is another example of an interactive session in accordance with aspects of the disclosure.

FIG. 14 is another example of an interactive session in accordance with aspects of the disclosure.

FIG. 15 is another example of an interactive session in accordance with aspects of the disclosure.

FIG. 16 is another example of an interactive session in accordance with aspects of the disclosure.

FIG. 17 is another example of an interactive session in accordance with aspects of the disclosure.

FIG. 18 is another example of an interactive session in accordance with aspects of the disclosure.

FIG. 19 is another example of an interactive session in accordance with aspects of the disclosure.

FIG. 20 is another example of an interactive session in accordance with aspects of the disclosure.

FIG. 21 is another example of an interactive session in accordance with aspects of the disclosure.

FIG. 22 is another example of an interactive session in accordance with aspects of the disclosure.

FIG. 23 is another example of an interactive session in accordance with aspects of the disclosure.

FIG. 24 is another example of an interactive session in accordance with aspects of the disclosure.

### DETAILED DESCRIPTION

Aspects, features and advantages of the disclosure will be appreciated when considered with reference to the following description of embodiments and accompanying figures. The same reference numbers in different drawings may identify the same or similar elements. Furthermore, the following description is not limiting; the scope of the present technology is defined by the appended claims and equivalents. While certain processes in accordance with example embodiments are shown in the figures as occurring in a linear fashion, this is not a requirement unless expressly stated herein. Different processes may be performed in a different order or concurrently. Steps may also be added or omitted unless otherwise stated.

The present disclosure generally relates to providing an image processing apparatus, method and system for interactively coupling images and other types of multimedia content (e.g., audio/video) with print media, such as a magazine, book, build board or daily periodical, etc., which may include in-store signage, marketing materials and other kinds of media. In some examples, the print media may include a digital image displayed by pixels on a display screen, where the display screen may be a separate display device, such as a display monitor, or part of another device that may have the capability to capture images of other kinds of media. These examples should not be considered as limiting the scope of the disclosure or usefulness of the features of the present disclosure. For example, the features and techniques described herein can be used with some types of actual, real-world products as well as various kinds of 3D objects. For instance, a device may used to capture images of a display of a real-world product, such as a sauce pan in a store. Object recognition may then be performed on the captured image to detect the presence of the sauce pan in the captured image, and when the object (sauce pan) is detected, the detection of the object can be used for interactively coupling images and other types of data, including multimedia data, that provide information and details on different product aspects, such as various kinds of material styles (cast iron, copper, etc.) available for the product as well as other kinds of product aspects or features related to the product.

The image processing according to the present disclosure may enhance a user's experience with the print media by allowing the user to interact or otherwise control aspects of electronic content associated with viewing the print media through a display screen of a client device, such as a mobile phone. In this regard, the print media may be positioned in a way so that a camera of the client device can capture images of a target item printed on the media. The captured image of the target item can be used as an identifier to retrieve an image related to the target item. This related image may include a plurality of image portions depicting various aspects of the target item.

One or more controls are provided at the client device. These controls may be made operable, for example, by the user touching an area of the display screen of the device. The controls may be configured to receive command information indicating an operation for an interactive session. In some examples, the interactive session may include simulating an operation of the target item, rotating a 360 degree view of the target item, scrolling through a carousel of different versions of the target item and providing other types of data regarding the target item, which may include various interactive data.

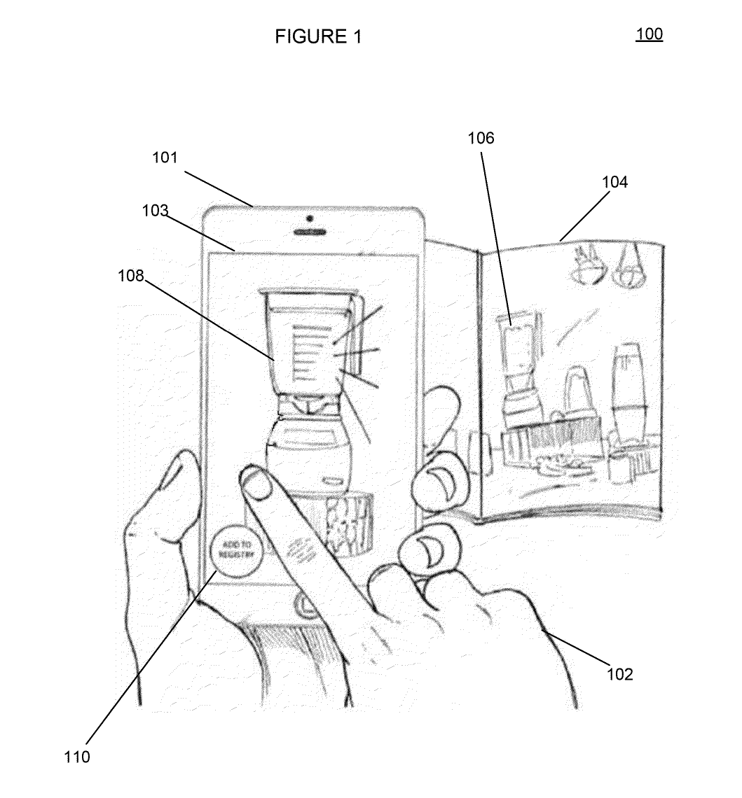

FIG. 1 illustrates an image capture process 100, which can be implemented using a computing device, such as client device 101. An application associated with the client device 101 may be operable to control the image capture process 100. For example, the application may be configured to activate a camera (not shown) associated with the client device 101 to capture a plurality of moving and/or still images of print media 104. In some embodiments, users may have to install the application and/or select a service in order to obtain the benefits of the techniques described herein. For example, user 102 may elect to download the application from a service associated with an online server. The client device 101 may transmit a request for the application over a network and, in response, receive the application from the service. Aspects of the application may be installed locally at the client device 101. In some examples, all or part of the application can be stored at the service and may be accessed through the client device 101, for example, via a web interface.

Using the application, the image capture process 100 can be initiated in several ways. For example, the user 102 can initiate the process 100 by providing an activation command associated with the application and an input device, such as a keyboard or touch screen display, of the client device 101. Alternatively, the presence of the print media 104 at the client device 101 can trigger the process 100. For example, the application can be configured to detect when a certain portion of print media 104 is being imaged by the camera and displayed on display screen 103 of the device 101. For example, this portion of the print media 104 may include a target item, such as item 106, which is being advertised for sale. In some examples, these captured images of the print media 104 may be stored locally at the client device 101 and/or transmitted to a server for later processing.

To detect item 106, the application may perform an image analysis on the images of the print media 104 being captured by client device 101. The image analysis may compare portions of an image of the print media 104 to a plurality of images in a database. In some examples, the images in the database may depict a 3D image of the target item. When an image, such as related image 108, is determined to sufficiently correspond with an image portion containing item 106, the item 106 is detected and the related image(s) 108 may be retrieved from the database and prepared for display. In one embodiment, the related image 108 may include a plurality of still images or moving images optionally including audio data. For example, as shown in FIG. 1, related image 108 may be displayed on the display screen 103 of device 101.

The application may be configured to control at least part of the related image 108 for an interactive session with the user 102. The application may be configured to recognize certain control instructions or gestures, for example, indicated by the user 102 touching the display screen 103 of client device 101. One such gesture may include, for example, the user 102 making contact with a portion of a surface of the display screen 103 and traversing that surface in a particular motion, direction or pattern. In response, the application may interact with the related image 108 in part or as a whole for controlling display of the related image 108 on the display screen 103.

In some embodiments, the user 102 can operate additional interactive features related to the target item 106, such as proceeding to an ecommerce site to retrieve other information related to the target item 106. This may be accomplished, for example, by the user 102 operating a pre-determined indicator, such as call-to-action indicator 110, displayed on the display screen 103 or by other techniques known in the art. In this regard, the user 102 may touch the call-to-action indicator 110, which in turn may cause additional interactive features related to the target item 106 to operate. In other examples, the additional interactive features may allow the user 102 to image the print media, which may include capturing a screen shot of an image displayed on a display device and interact with an informative interactive session, for example, to purchase the target item 106 or add the item to a registry, online chart or wish list, or enable other types of interactions. In some examples, the user 102 may also be able to add the item 106 directly to a shopping list or reserve the item 106 at a brick and mortar store directly from the additional interactive features.

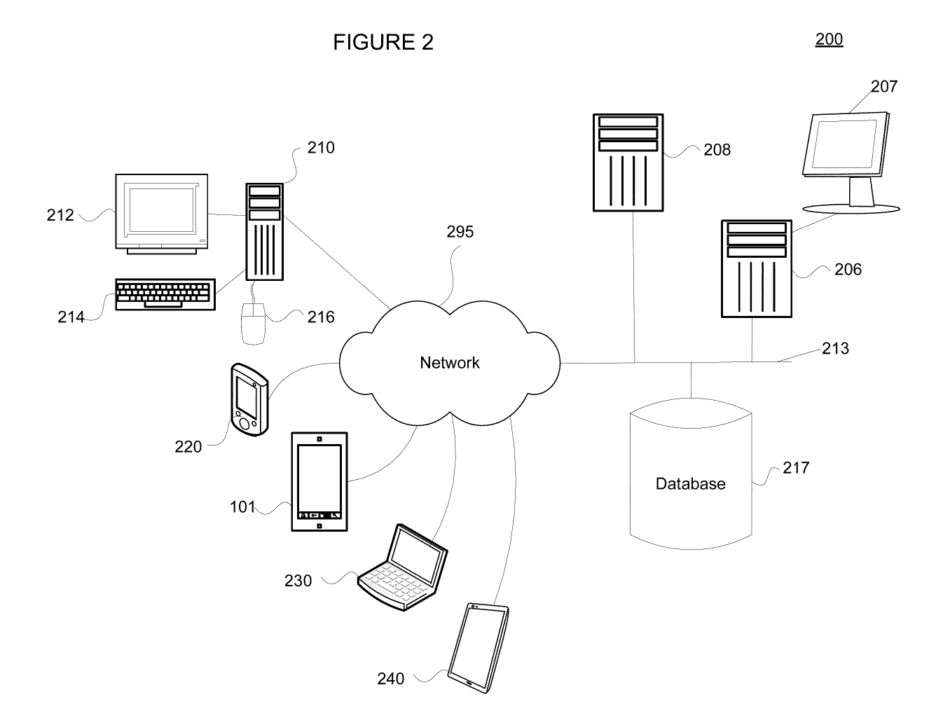

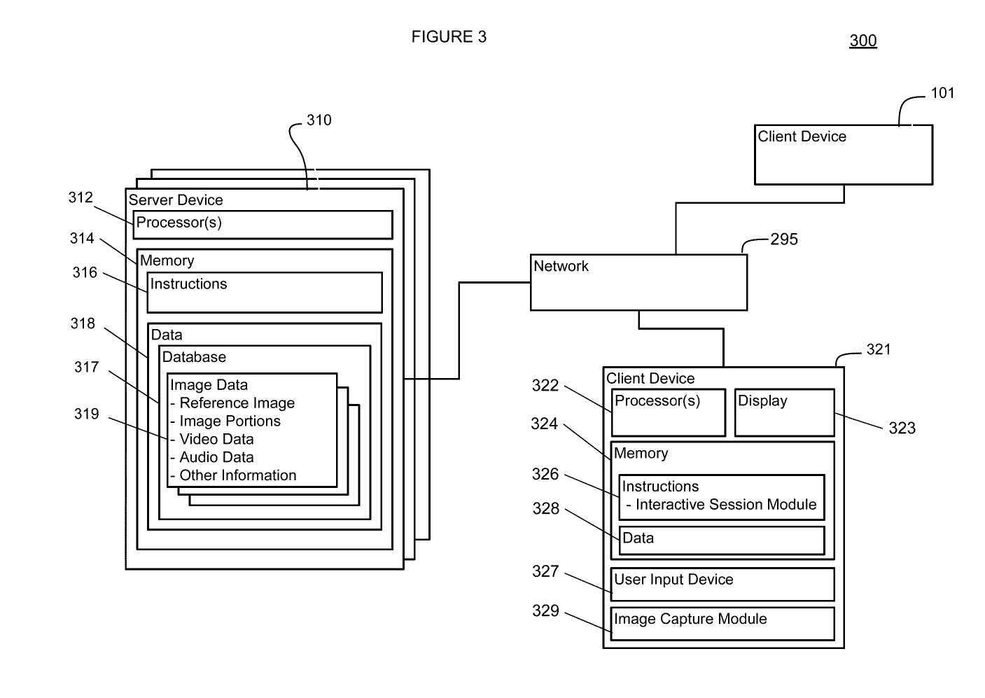

While it can be possible to perform aspects of the techniques described herein with an application installed on client device 101 at a standalone location, such as a mobile phone or tablet device at the user's present location, it may also be feasible to do some image processing at remotely dispersed locations as well as locally (or some combination thereof). For instance, a remote server of a system may perform some or all aspects of the image analysis/processing for the interactive session. Examples of these types of systems are discussed in further detail below with respect to FIGS. 2 and 3.

FIG. 2 is a pictorial diagram of a system 200, which may be used to implement aspects of the present disclosure as described herein. As shown, system 200 depicts various computing devices that can be used alone or in a networked configuration. For example, this figure illustrates a computer network having a plurality of computing devices 208 and 206, e.g., computing devices located at a server farm, as well as client device 101 and other types of computing devices, such as computer terminal 210, PDA 220, laptop/netbook 230 and tablet 240. The various computing devices may be interconnected via a local bus or direct connection 213 and/or may be coupled via a communications network 295 such as a LAN, WAN, the Internet, etc. and which may be wired or wireless.

Each device may include, for example, user input devices such as a keyboard 214 and mouse 216 and/or various other types of input devices such as pen-inputs, joysticks, buttons, touch screens, etc., as well as a display 212, which could include, for instance, a CRT, LCD, plasma screen monitor, TV, projector, etc. Each device may be a personal computer, application server, etc. By way of example only, computing device 206 may be a personal computer while computing device 208 may be a server. Databases, such as database 217, may be accessible to one or more of the computing devices or other devices of system 200.

FIG. 3 is a block diagram of a system 300. As shown the system 300 may include one or more computing devices, such as server device 310, coupled to network 295 and a number of mobile computing devices, such as client devices 101 and 321, capable of communicating with the one or more server devices over the network 295. The one or more server devices may include one or more processors 312, memory 314, and other components typically present in general purpose computers. Each processor of the one or more processors 312 may be a conventional processor, such as a processor found in commercially available computers. Alternatively, each processor may be a dedicated controller, such as an ASIC, FPGA or other hardware-based processors.

Memory 314 may store information that is accessible by the processors 312, including instructions 316 that may be executed by the processors 312, and data 318. The memory 314 may be of a type of memory including a non-transitory computer-readable medium, or other medium that stores data read with the aid of an electronic device, such as a hard-drive, memory card, read-only memory (“ROM”), random access memory (“RAM”), digital versatile disc (“DVD”) or other optical disks, as well as other write-capable and read-only memories. The subject matter disclosed herein may include different combinations of the foregoing, whereby different portions of the instructions 316 and data 318 are stored on different types of media.

Although FIG. 3 functionally illustrates the processors 312 and memory 314 as being within the same block, the processors 312 and memory 314 may actually include multiple processors and memories that may or may not be stored within the same physical housing. For example, some of the instructions 316 and data 318 may be stored on removable CD-ROM and others within a read only computer chip. Some or all of the instructions 316 and data 318 may be stored in a location physically remote from, yet still accessible by, the processors 312.

Similarly, the processors 312 may actually comprise a collection of processors, which may or may not operate in parallel. For instance, various methods described below as involving a single component (e.g., one of the processors 312) may involve a plurality of components, e.g., multiple computing devices distributed over a network of computing devices, computers, “racks,” etc. as part of a parallel or distributed implementation. Further, various functions performed by the embodiments described herein may be executed by different computing devices at different times as load is shifted from among computing devices. Similarly, various methods described below as involving different components (e.g., client device 101 and client device 321) may involve a single component, e.g., rather than client device 101 performing a determination described below, device 101 may send relevant data and/or images to server 312 for processing and receive the results of the determination for further processing or display.

Data 318 may be retrieved, stored or modified by the processors 312 in accordance with the instructions 316. Although the present disclosure is not limited by a particular data structure, the data 318 may be stored in computer registers, in a relational database as a table having a plurality of different fields and records, XML documents, or flat files. The data 318 may also be formatted in a computer readable format such as, but not limited to, binary values, ASCII or Unicode. By further way of example only, the data 318 may be stored as images comprised of pixels that are stored in compressed or uncompressed, or various image formats (e.g., JPEG), vector-based formats (e.g., SVG) or computer instructions for drawing graphics. For example, the data may include one or more images of print media, which may include information relevant to the images such as a timestamp, latitude/longitude coordinates and other data. Moreover, the data 318 may comprise information sufficient to identify relevant information, such as numbers, descriptive text, proprietary codes, pointers, references to data stored in other memories (including other network locations) or information that is used by a function to calculate the relevant data. For example, the data 318 may include a database 317 that comprises image data 319 regarding a plurality of different target items, which may include information relevant to identifying images of an individual target item from the database 317.

Database 317 (which may be compared to database 217 of FIG. 2) may store image data 319 that may be transmitted to other computing devices of system 300. The image data 319 may include images related to target items that may be printed on print media. The image data 319 can also include other information relevant to the target items. For instance, the image data 317 may store a reference image representing a given target item and a plurality of image portions depicting different aspects of the given target item. The image data 317 may also include video and audio data related to a presentation of information regarding the target item as well as other types of information.

The server device 310 may query database 317 for images related to an image of a target item. For example, the server device 310 may retrieve the images in response to a request from the client device 321. The server device 310 may compare the image of a target item to the reference images in the database 317 in order to determine if the two images correspond. Visual similarities between the images may be verified, for example, based on a visual analysis of the images. This visual analysis may search for features that correspond in pixilation, shape, coloring, position, orientation, etc., or by comparing other types of image features associated with each image.

In some embodiments, the database 317 may be internally included with the server device 310. For example, as shown, the database 317 may be in the memory 314 of server device 310. In other embodiments, the database 317 may be a separate component from server device 310. For example, the database 317 can be divided into multiple databases with components that can be geographically dispersed at different locations that are reachable via network 295.

Server device 310 may be at one node of network 295 and capable of directly and indirectly communicating with other nodes of the network 295. For example, the server device 310 may include a web server that may be capable of communicating with client devices 101 and 321 via network 295 such that it uses the network 295 to transmit and display information to a user on a display associated with client device 101 and/or client device 321. The server 310 may also include a plurality of computers that exchange information with different nodes of a network for the purpose of receiving, processing and transmitting data to the client devices. In this instance, the client devices, such as client devices 101 and 321, will typically still be at different nodes of the network 295 than the computers comprising server device 310.

Network 295, and intervening nodes, may include various configurations and protocols including the Internet, World Wide Web, intranets, virtual private networks, wide area networks, local networks, private networks using communication protocols proprietary to one or more companies, Ethernet, WiFi, e.g., 802.11, 802.11b, g, n, or other such standards, HTTP, and various combinations of the foregoing. Such communication may be facilitated by a device or devices capable of transmitting data to and from other computers, such as modems, e.g., dial-up, cable or fiber optic, and wireless interfaces.

Although certain advantages are obtained when information is transmitted or received as noted above, other aspects of the subject matter disclosed herein are not limited to a particular manner of transmission of information. For example, in some aspects, information may be sent via a medium such as a disk, tape or CD ROM. Yet further, although some functions are indicated as taking place on a single server having a single processor, various aspects may be implemented by a plurality of servers, for example, communicating information to client devices 101 and 321 over network 295.

Each client device 101 and 321 may be configured similarly to the server device 310, with one or more processors 322, memory 324, instructions 326, data 328 and all of the internal components normally found in a personal computer. By way of example only, the client device 321 may include a central processing unit (CPU), such as one of the processors 322, display device 32, such as a monitor having a screen, a projector, a touch-screen, a small LCD screen, a television, or another device such as an electrical device that is operable to display information processed by the processors 322, CD ROM, hard drive, user input device 327 such as a keyboard, mouse, touch screen or microphone, sensors, speakers, modem and/or network interface device (e.g., telephone, cable or otherwise) and all of the components used for connecting these elements to one another.

As shown in FIG. 3, client device 321 may also include an image capture module 329. The image capture module 329 can be used to capture still or moving images of an object, which can be stored in data 328. The image capture module 329 may be a software module operable in conjunction with a camera or may include a moving image capturing device, such as a video digital camera having image processing components. For example, the client device 321 may be connected to a video digital camera that can operate in conjunction with the image capture module 329. The image capture module 329 can also operate in conjunction with other image capturing systems known in the arts such as a digital camera with still and/or moving image capture capabilities, a camera in a mobile phone, a video camera or other devices with image capturing features.

By way of example only, client devices 101 and 321 may be personal computing devices. For example, client device 321 may be a laptop computer, a netbook, a desktop computer, and a portable personal computer such as a wireless-enabled PDA, a tablet computer or another type of computing device capable of obtaining information via a network like the Internet. Although aspects of the disclosure generally relate to a single computing device, the personal computing device may be implemented as multiple devices with both portable and non-portable components (e.g., software executing on a rack-mounted server with an interface for gathering image information).

Although client device 321 may include a full-sized personal computer, the subject matter of the present disclosure may also be used in connection with mobile computing devices capable of wirelessly exchanging data. For example, client device 321 may be a wireless-enabled mobile computing device, such as a Smartphone, or an Internet-capable cellular phone. In either regard, the user may input information using a small keyboard, a keypad, a touch screen or other means of user input. In various aspects, the client devices and computers described herein may comprise a device capable of processing instructions and transmitting data to and from humans and other devices and computers.

Instructions 316 and 326 of the server device 310 and client device 321 respectively may be a set of instructions to be executed directly (such as machine code) or indirectly (such as scripts) by the processor. In that regard, the terms “instructions,” “steps” and “programs” may be used interchangeably herein. The instructions 316 and 326 may be stored in object code format for direct processing by the processor, or in another computer language including scripts or collections of independent source code modules that are interpreted on demand or compiled in advance. Processes, methods and routines of the instructions are explained in more detail below.

In order to facilitate the operations of system 300, the client device 321 may further include an interaction session module in the instructions 326 for detecting target items in images captured from printed media and processing images related to the target item that are retrieved from database 317. The functionally of the interaction session module can exist in a fewer or greater number of modules than what is shown, with such modules residing at one or more computing devices, which may be geographically dispersed. The modules may be operable in conjunction with client device 321 from which it may receive electronic content including images and other types of multi-media information related to target items as well as relevant information regarding those images and items. A user may enter commands via the client device 321 in order interact with an interaction session created by using interactive content associated with the target item information.

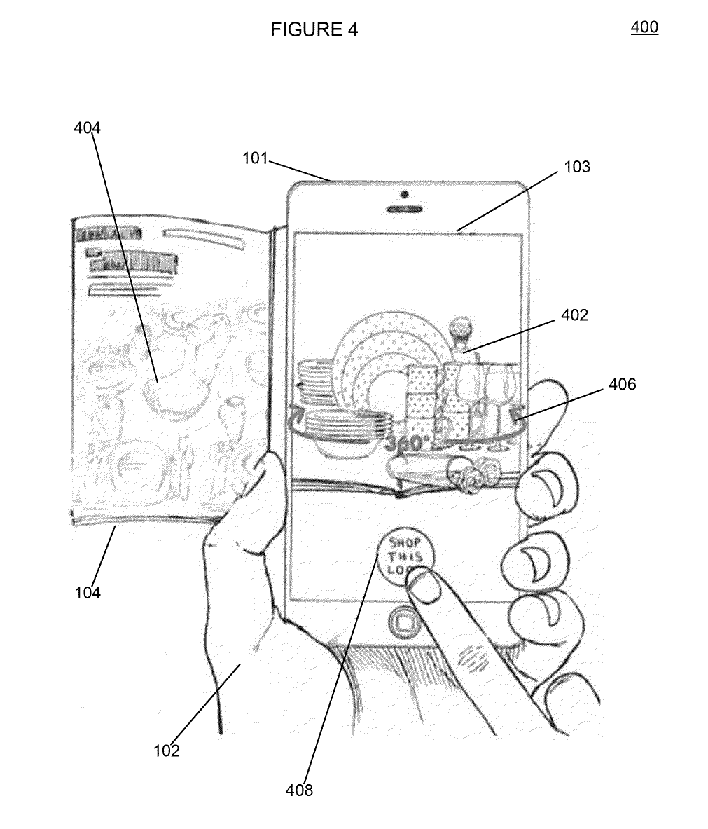

With reference to FIG. 4, an illustration of an interactive session 400, which can be implemented using client device 101 of system 300, is shown. In this example, user 102 is able to interact with a full screen presentation of a related image 402 associated with a corresponding image of target item 404 captured from print media 104. As noted above, an application, such as the interaction session module of system 300, installed on client device 101 may perform an image analysis on images of the print media 104 in order to detect the target item 402 printed thereon. Then, the application may retrieve the related image 402 from database 317. In this example, the related image 402 may include a plurality of image portions depicting a 360 degree view of the target item 404.

Using device 101, the user 102 can interact in the interactive session 400, for example, by scrolling the related image 402 in different directions in order to view the target item 404 from various perspectives. In some examples, the user 102 may, with a finger, make contact with a portion of display screen 103 and then swipe the screen in a particular direction (e.g., up, down, left and right). When the user swipes the display screen 103, the 360 degree view of the target item may rotate between a first degree view and a second degree view as indicated by directional arrow 406. In some examples, the 360 degree view may include a 360 degree view of the target item 404 from various axial points that includes a view from over the item 404 or under the item 404. By continuing to rotate the related image 402, a perspective view completely around (or over, or under) the target item 404 may be displayed by display of the plurality of image portions depicting the 360 degree view. In some embodiments, the user 102 can proceed to an ecommerce site to purchase the target item 404 or add the item to a registry or shopping chart, for example, by touching a pre-determined indicator, such as indicator 408, displayed on the display screen 103 or by other techniques known in the art.

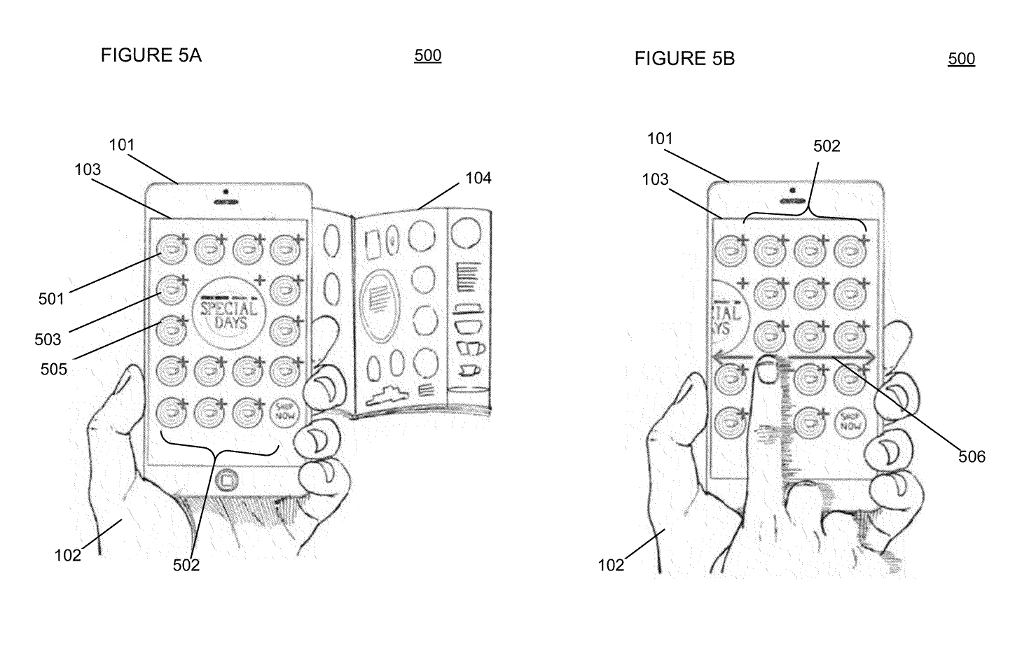

FIGS. 5A-5B are another example of an interactive session 500. In this example, the user 102 is able to interact with a full screen product carousel 502 of target items, such as target items 501, 503 and 505. As shown in FIG. 5A, the product carousel 502 may include images depicting different versions of a given target item for scrollable display. As noted above, the images may be retrieved from database 317 based on detecting the given target item in images captured from print media 104.

In FIG. 5B, the user 102 is shown interacting with the interactive session 500, for example, by scrolling the product carousel 502 in different directions. As noted above, the user 102 may make contact with a portion of display screen 103 and swipe the screen in a particular direction. For example, when the user swipes the display screen 103, the images of the different versions of the target item may be displayed moving in one direction from one side of display screen, across the display screen, while the current page of images is displayed moving in the one direction and gradually disappearing (not being displayed) at the opposite side of the display screen 103, so that a predetermined page of target item images can appear. For example as shown in FIG. 5B, the product carousel 502 may scroll the images of the different versions of the target item in the directions indicated by arrow 506 (e.g., left and right). Here to, the user 102 can proceed to an ecommerce site to purchase or add any of the target items of the product carousel 502 to a registry or shopping chart, for example, by touching a pre-determined indicator disposed on the display screen 103, the image of the target item itself or by other techniques known in the art.

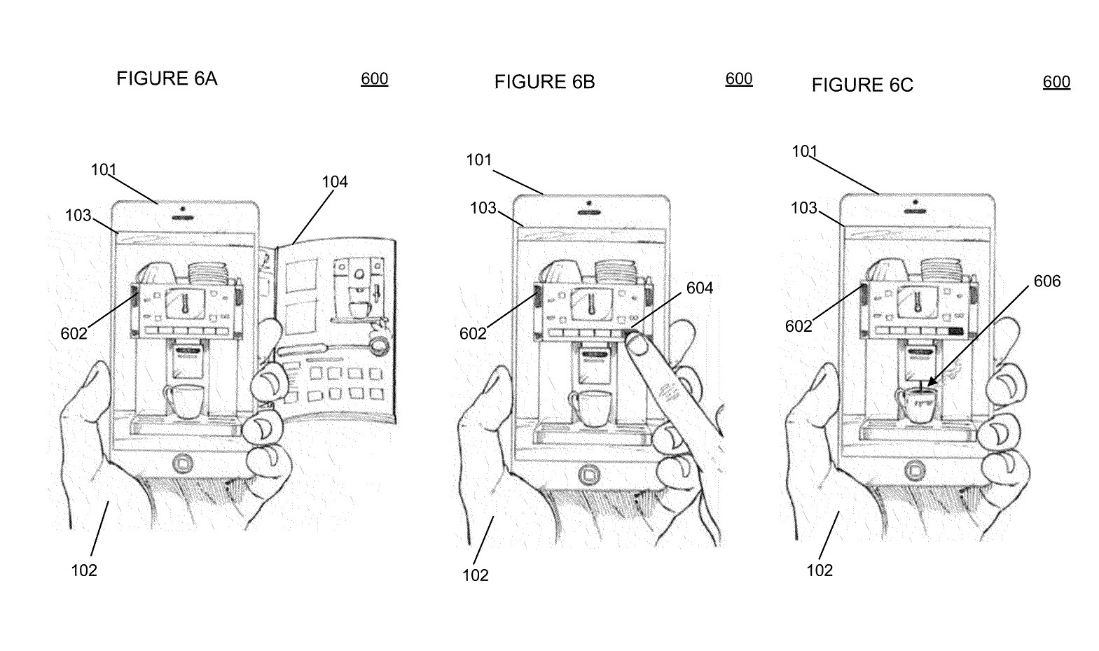

In FIGS. 6A-6C, yet another example of an interactive session 600 is shown. In this example, user 102 may interact with a full screen product simulation of target item 602. Here, the target item 602 is a coffee maker. Turning to FIG. 6A, as noted above an application may perform an image analysis of images of print media 104 in order to detect the target item 602 printed thereon. The user 102 may interact with a related image corresponding to the target item 602, for example, by operating the various buttons or controls of the item 602 as depicted on the related image displayed during the product simulation session on display screen 103.

As shown, in FIG. 6B, the user 102 may make contact with or touch an area of the related image displayed on display screen 103 that corresponds to a control feature, such as control button 604, which is part of the target item 602. In response, a simulated operation of the target item 602 may be displayed on the display screen 103. In some examples, the control features may be linked to a series of image portions that, when displayed in sequence one after another, depicts the simulated operation of the target item. For example, the displayed area of the target item 602 represented by control button 604 may be linked to a series of images related to target item 602. As noted above, these images may be retrieved from database 317 of system 300. By a user contacting the area on the display screen 103 at which the control button 604 is displayed, the series of image portions may be displayed on display screen 103 at a certain area corresponding to a given operation location of the target item 602 associated with the control button 604. For example, the series of image portions may be combined, superimposed, overlaid, etc., with a portion or an entirety of the image of the target item 602 at display screen 103. Thereupon, the image portions may be displayed in sequence so as to simulate operation of the target item 602 at the given operation location.

As shown in FIG. 6C, in response to input from user 102 at the button 604, the interactive session 600 may display a sequence of related image portions simulating an operation of the target item 602 as indicated by arrow 606. For example, here, in response to the user input, the displayed related images portions may show a simulation of target item 602 in operation making a cup of coffee. An advantage of such interactive product simulation session is that operational features of the target item 602 can be explained and illustrated in a way for the user 102 to experience use and operating features of the item without having to actually go to a brick and mortar store to do the same.

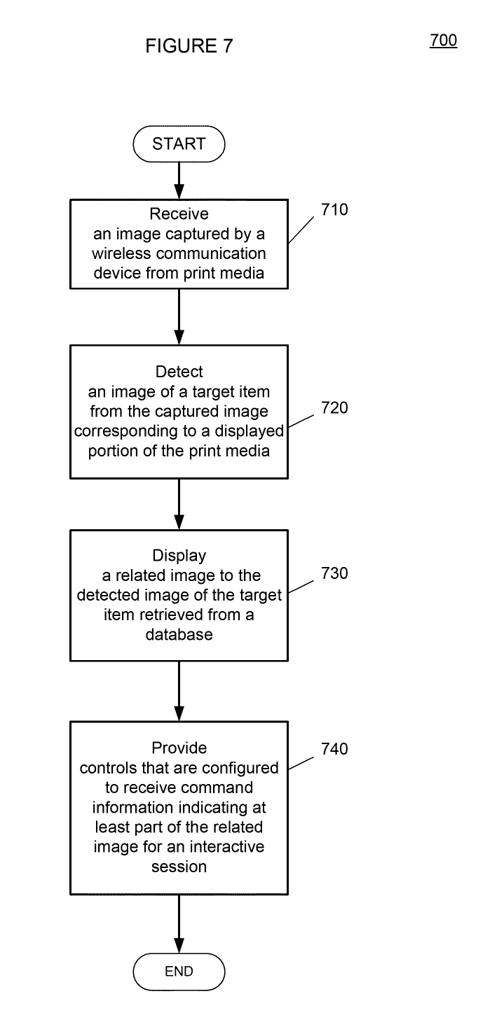

To better aid in understanding an example of some of the aspects described above, reference is now made to FIG. 7, which is a flow diagram 700. As previously discussed, the following operations do not have to be performed in the precise order described below. Rather, as mentioned above, various operations can be handled in a different order or simultaneously, and operations may be added or omitted.

In block 710, an image captured by a wireless communication device from print media may be received. For example, the image may be captured using a camera associated with a client device. In some examples, still or moving images of the print media may be captured by the camera and displayed on a display screen associated with the device.

In block 720, an image of a target item may be detected from the image captured in block 710. The image may correspond to the displayed portion of the print media. For example, wireless communication device may perform an image analysis on images of the print media 104 in order to detect the target item printed thereon.

In block 730, a related image to the detected image of the target item from block 720 may be retrieved from a database and prepared for display. For example, in response to a request from the wireless communication device, the related image may be retrieved. The related image may sufficiently correspond to the detected image of the target item. The related image may include a plurality of image portions and other data related to various aspect of the target item.

In block 740, one or more controls may be provided, for example, at the wireless communication device. The controls may be configured to receive command information indicating that at least part of the related image from block 730 may be used for an interactive session. These controls may allow the user to interact with the related image. For example, the controls may allow the user to simulate an operation of the target item, rotate 360 degrees around a view of the target item, scroll through a carousel of different versions of the target item and provide other types of information regarding the target item.

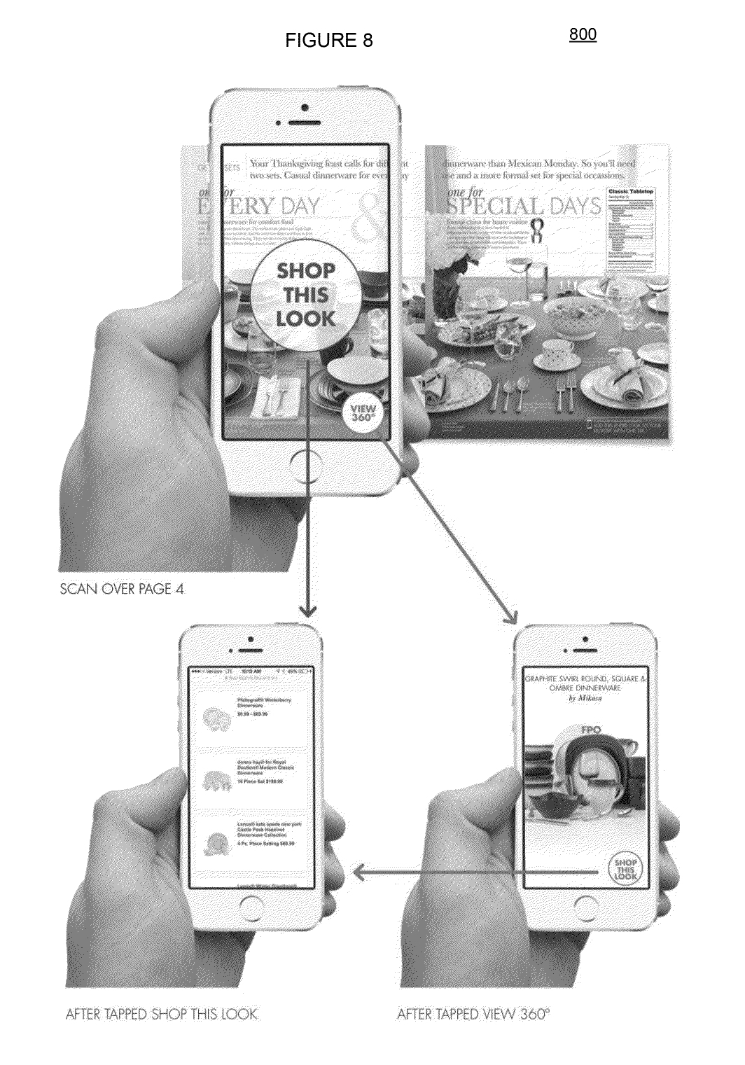

FIG. 8 is another example of an interactive session 800 having features similar to interactive session 400 of FIG. 4. In this example, the user can interact in the interactive session 800 to control a view of the target item or to order or receive additional information regarding the target item.

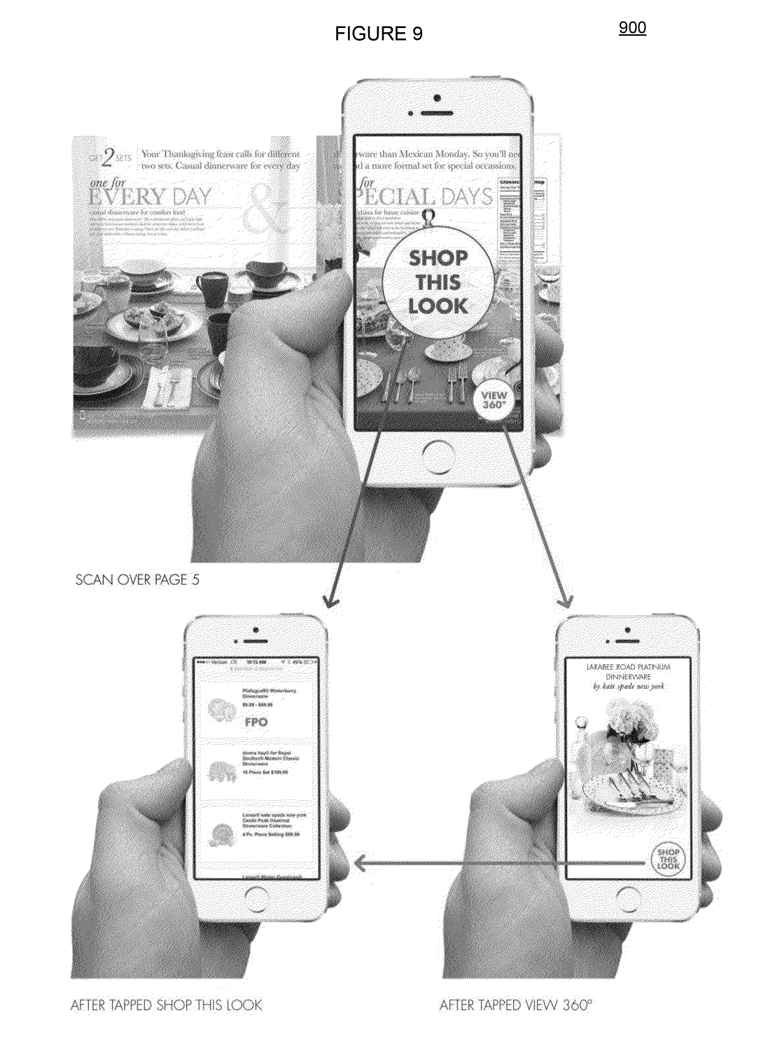

FIG. 9 is another example of an interactive session 900 having features similar to interactive session 400 of FIG. 4. In this example, the user can interact in the interactive session 900 to control a view of the target item or to order or receive additional information regarding the target item.

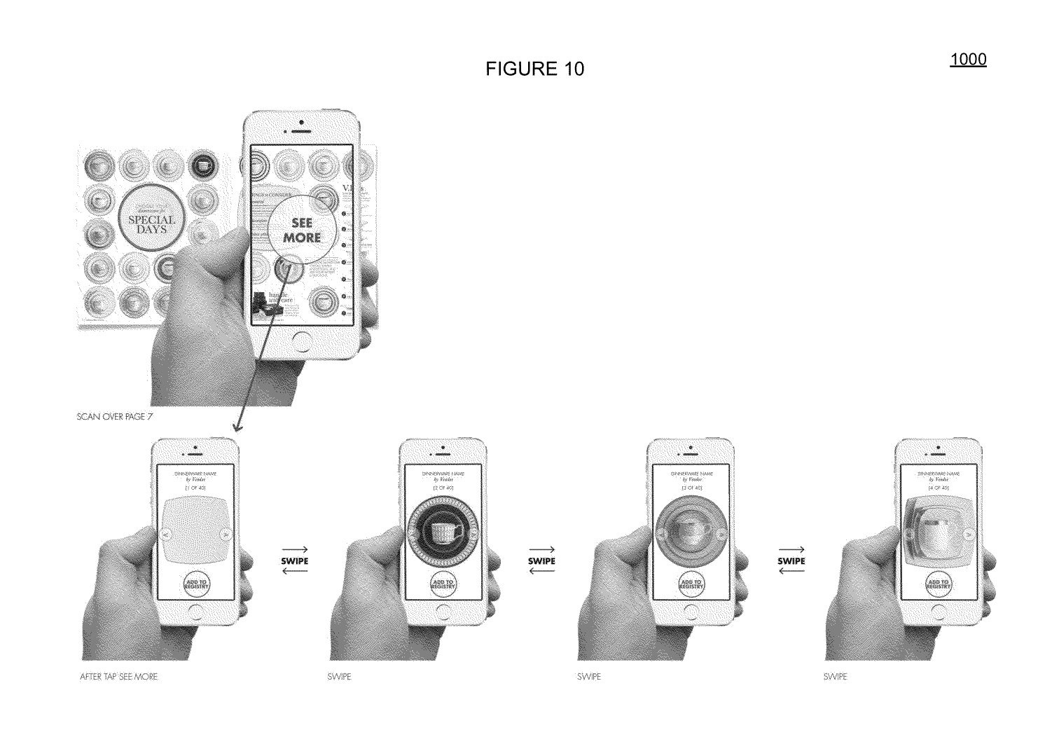

FIG. 10 is another example of an interactive session 1000 having features similar to interactive session 500 of FIG. 5. In this example, the interactive session 1000 includes a full page spread of an object or a plurality of objects, such as a table setting, featured in the print media. The captured image includes only a portion of the print media, and when a given target item is tapped, a full page view of the target item, such as a full table setting, is displayed. This allows the user to interact with the interactive session 1000 using different kinds of actions, such as a swipe action on the display screen.

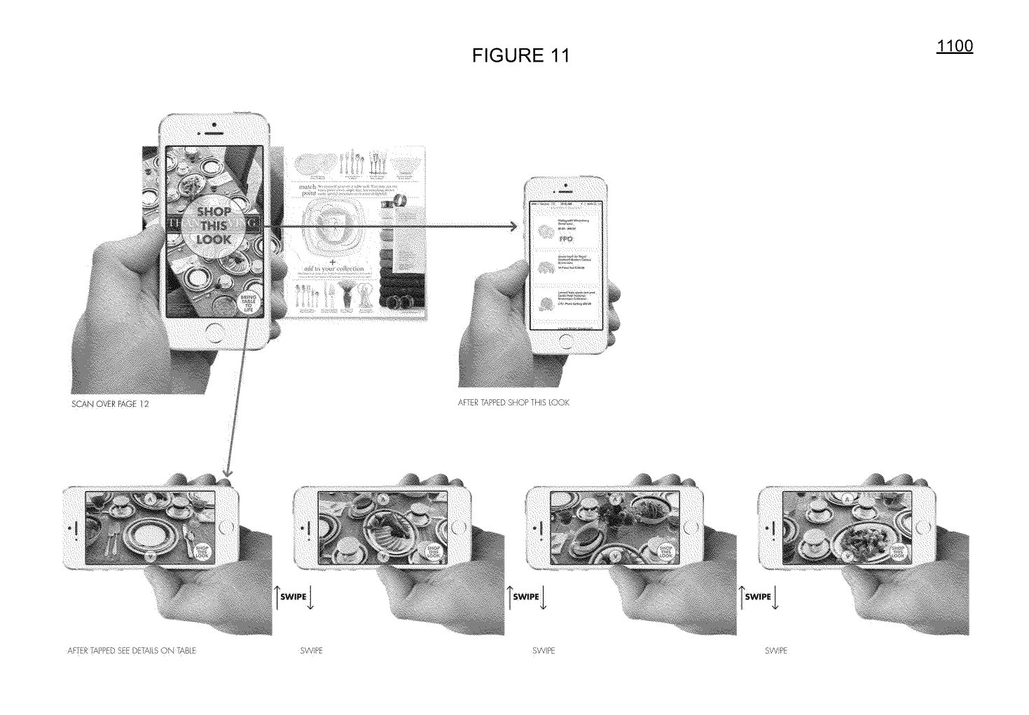

FIG. 11 is another example of an interactive session 1100 having features similar to interactive session 400 of FIG. 4. In this example, the interactive session 1100 includes a full page spread of a plurality of objects, such as a table setting, featured in the print media. The captured image includes only a portion of the print media, and when a given target item is tapped, a full page view of the target item is displayed. This allows the user to interact with the interactive session 1100 using different kinds of actions, such as a swipe action on the display screen.

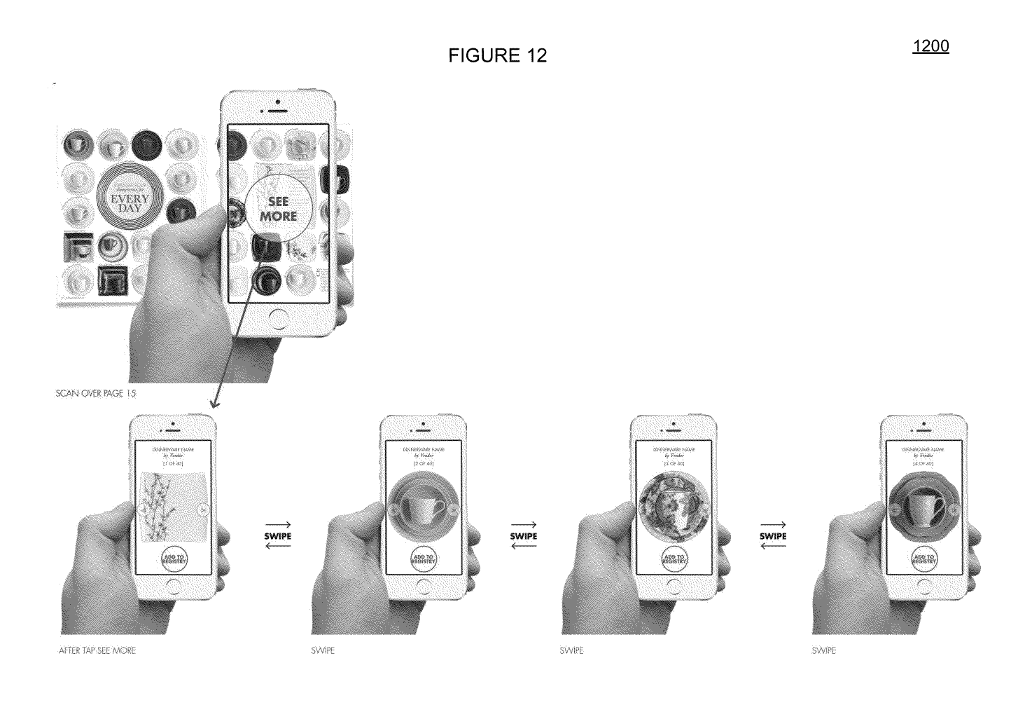

FIG. 12 is another example of an interactive session 1200 having features similar to interactive session 400 of FIG. 4. In this example, the interactive session 1200 includes a full page spread of a plurality of objects, such as a table setting, featured in the print media. The captured image includes only a portion of the print media, and when a given target item is tapped, a full page view of the target item, is displayed. This allows the user to interact with the interactive session 1200 using different kinds of actions, such as a swipe action on the display screen.

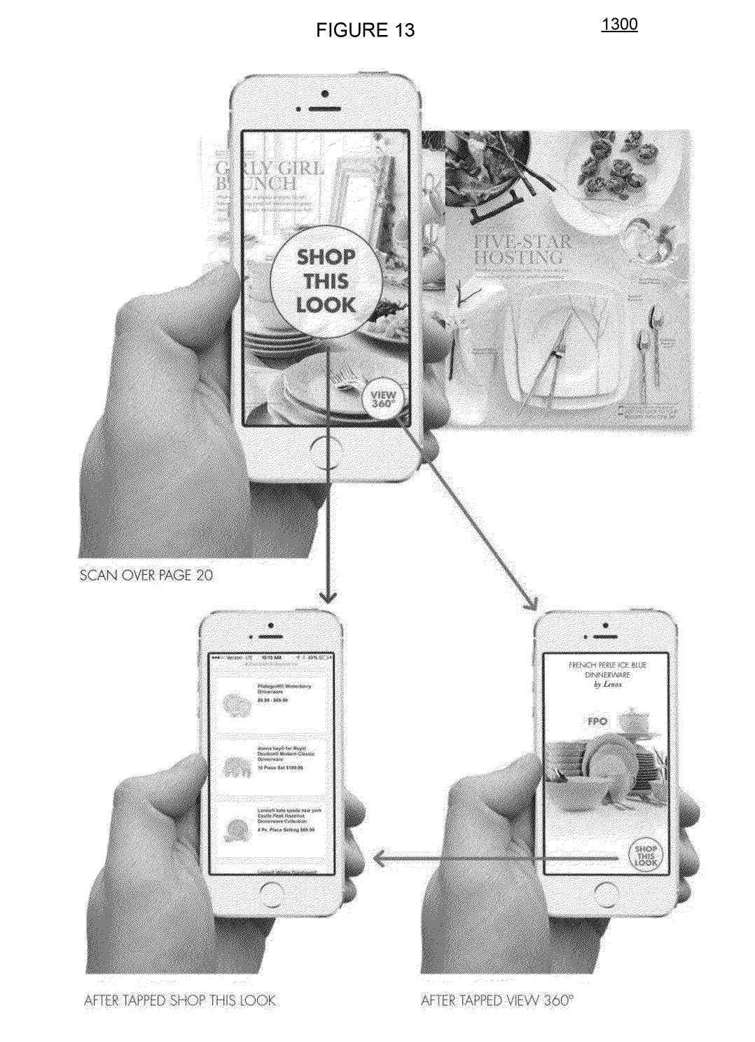

FIG. 13 is another example of an interactive session 1300 having features similar to interactive session 400 of FIG. 4. In this example, the user can interact in the interactive session 1300 to control a view of the target item or to order or receive additional information regarding the target item.

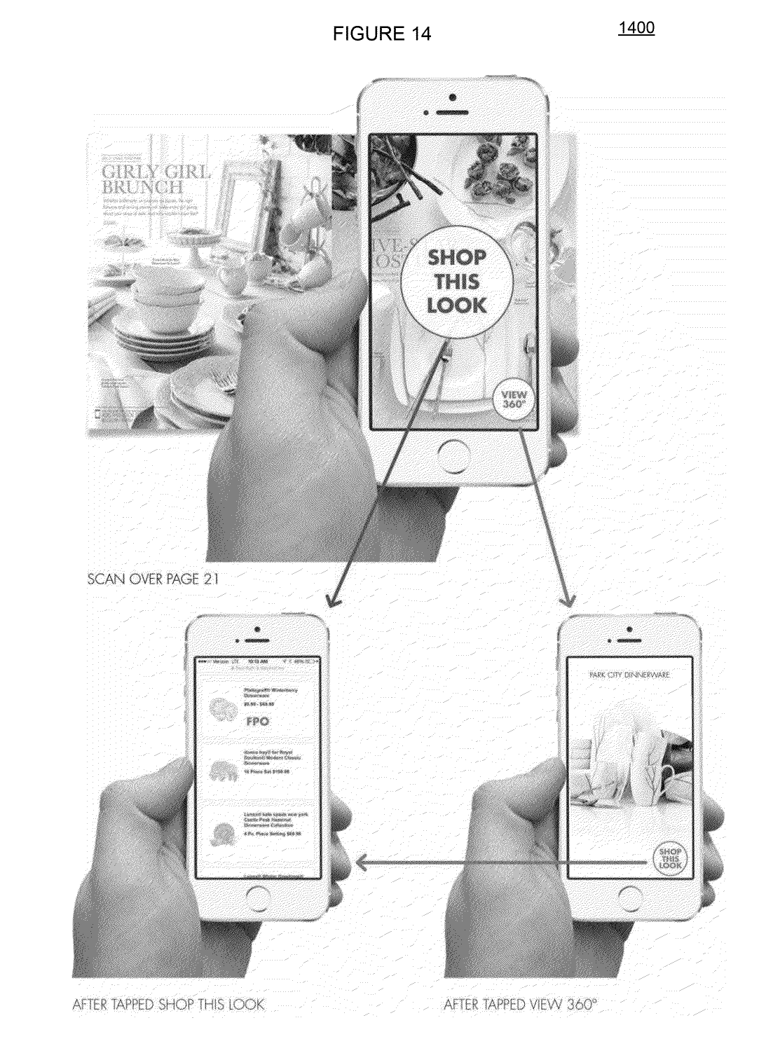

FIG. 14 is another example of an interactive session 1400 having features similar to interactive session 400 of FIG. 4. In this example, the user can interact in the interactive session 1400 to control a view of the target item or to order or receive additional information regarding the target item.

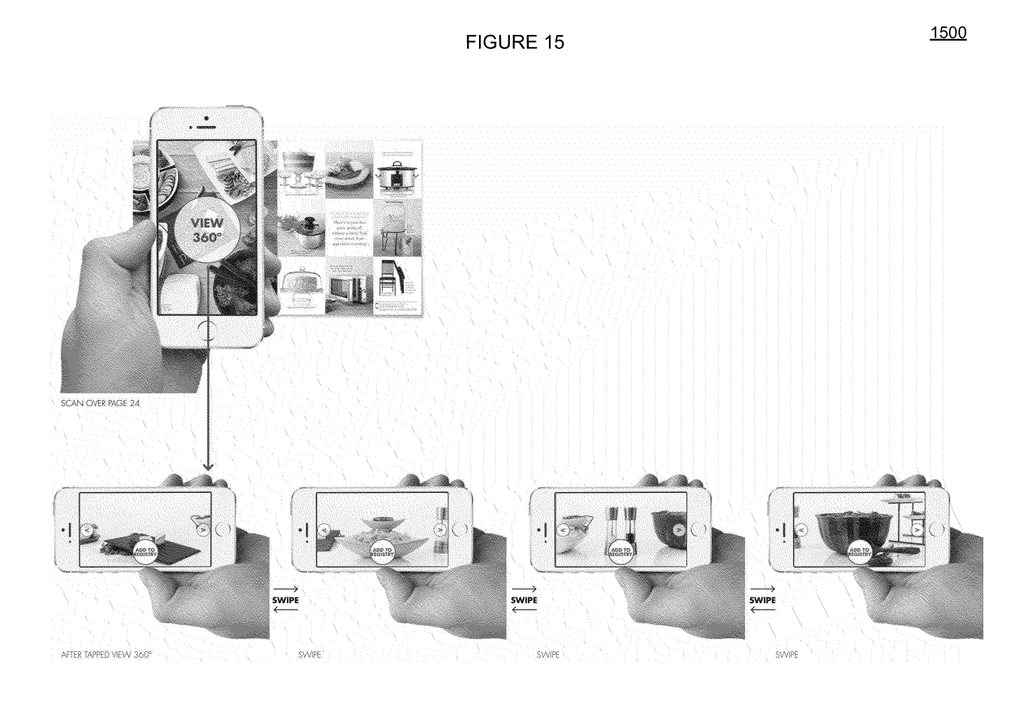

FIG. 15 is another example of an interactive session 1500 having features similar to interactive session 400 of FIG. 4. In this example, the interactive session 1500 includes a variety of different types of target items for display, so as to provide a single carousel experience. For example, an entire styled tabletop scene of target items may be displayed in a carousel style, by swiping, and also to allow that the target items may be purchased, added to a registry or the like.

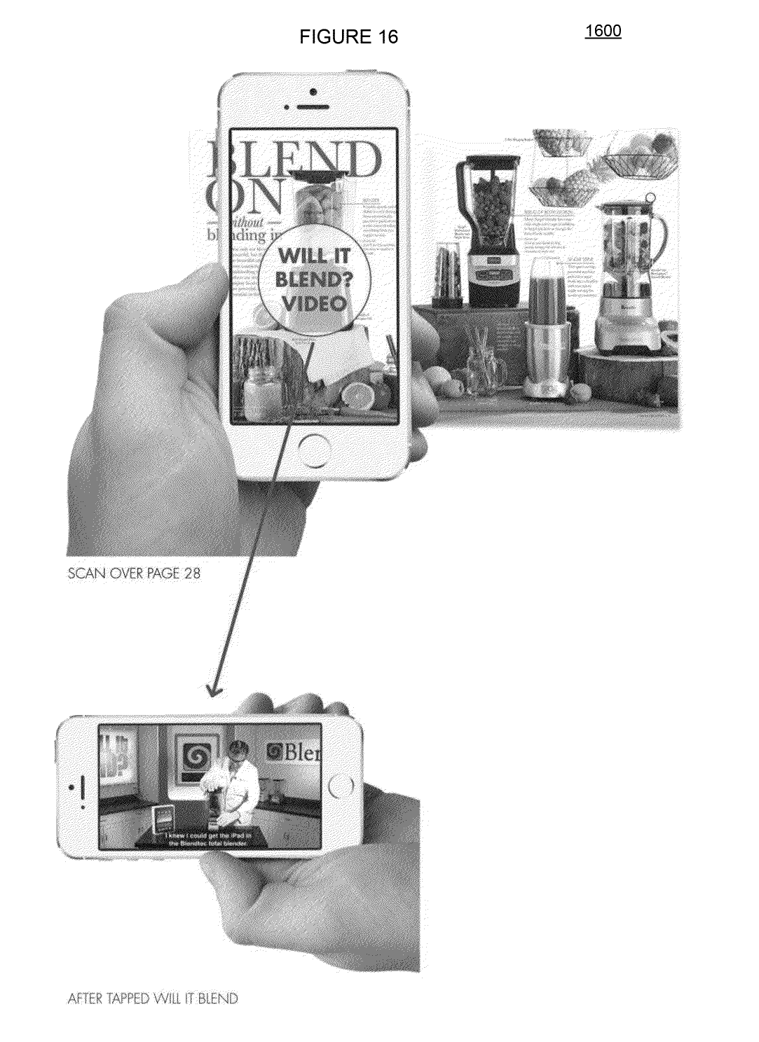

FIG. 16 is another example of an interactive session 1600 having features similar to interactive session 400 of FIG. 4. In this example, the interactive session 1600 includes additional multimedia data linked to the captured image of the target item.

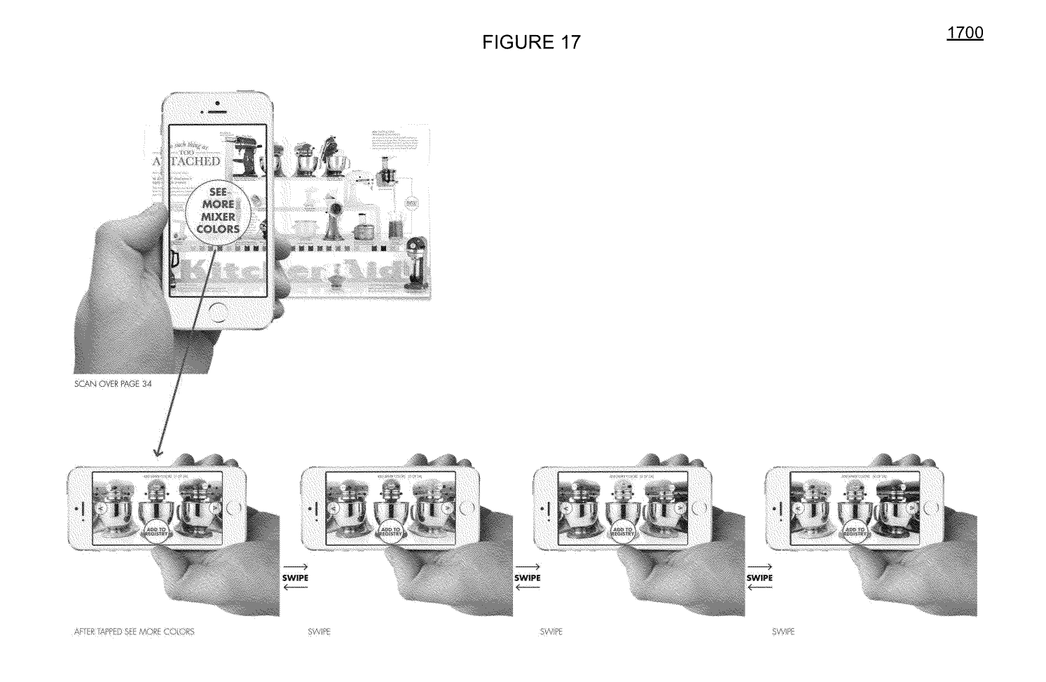

FIG. 17 is another example of an interactive session 1700 having features similar to interactive session 500 of FIG. 5. In this example, the interactive session 1700 includes a full screen view scrollable carousel display of a target item in a variety of styles, e.g., colorwaves.

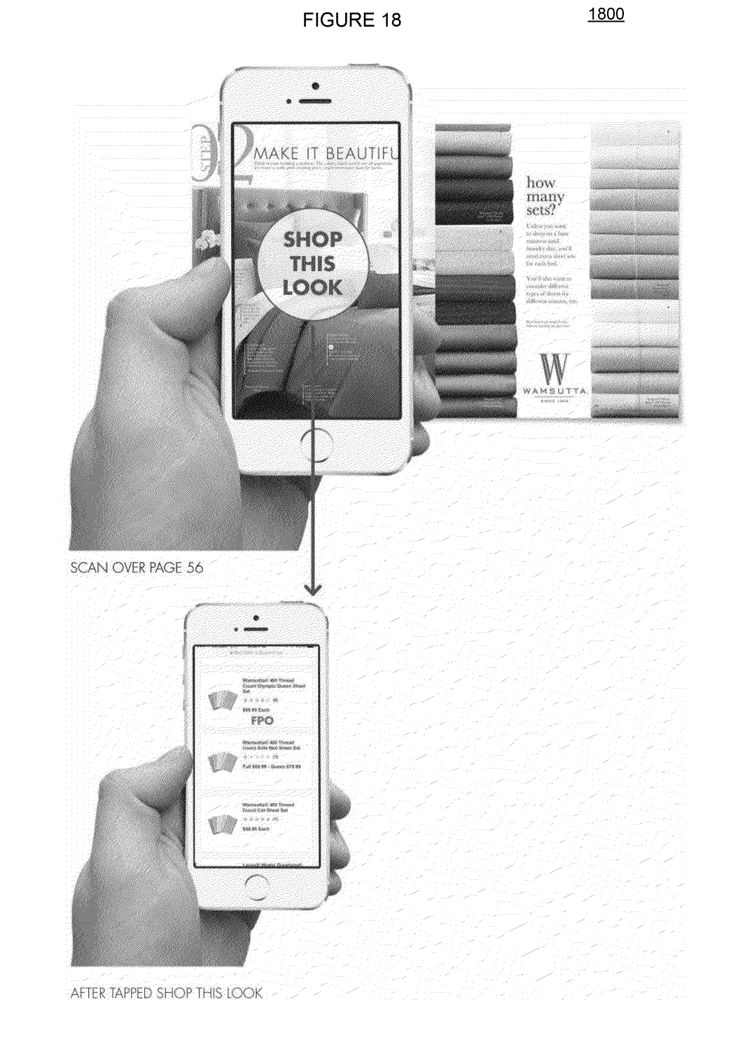

FIG. 18 is another example of an interactive session 1800 having features similar to interactive session 400 of FIG. 4. In this example, the user can interact in the interactive session 1800 to control a view of the target item or to order or receive additional information regarding the target item.

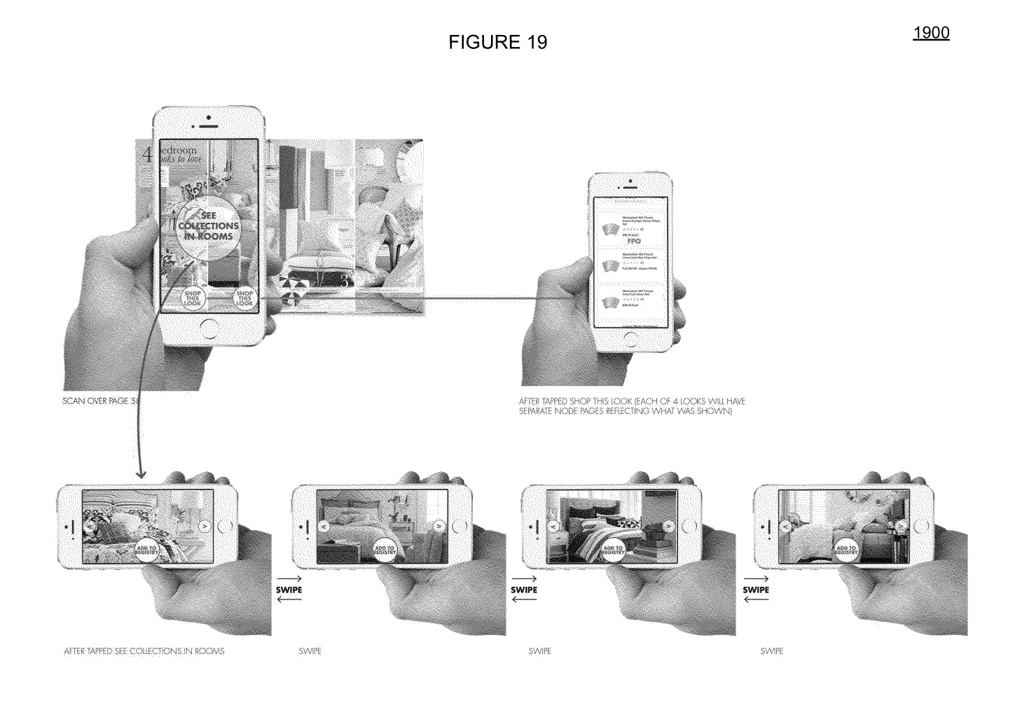

FIG. 19 is another example of an interactive session 1900 having features similar to interactive session 400 of FIG. 4. In this example, the interactive session 1900 includes a full page spread of a plurality of objects, such as different styles of bedding, featured in the print media. The captured image includes only a portion of the print media, and when a given target item is tapped, a full page view of the target item is displayed. This allows the user to interact with the interactive session 1900 using different kinds of actions like a swipe action on the display screen.

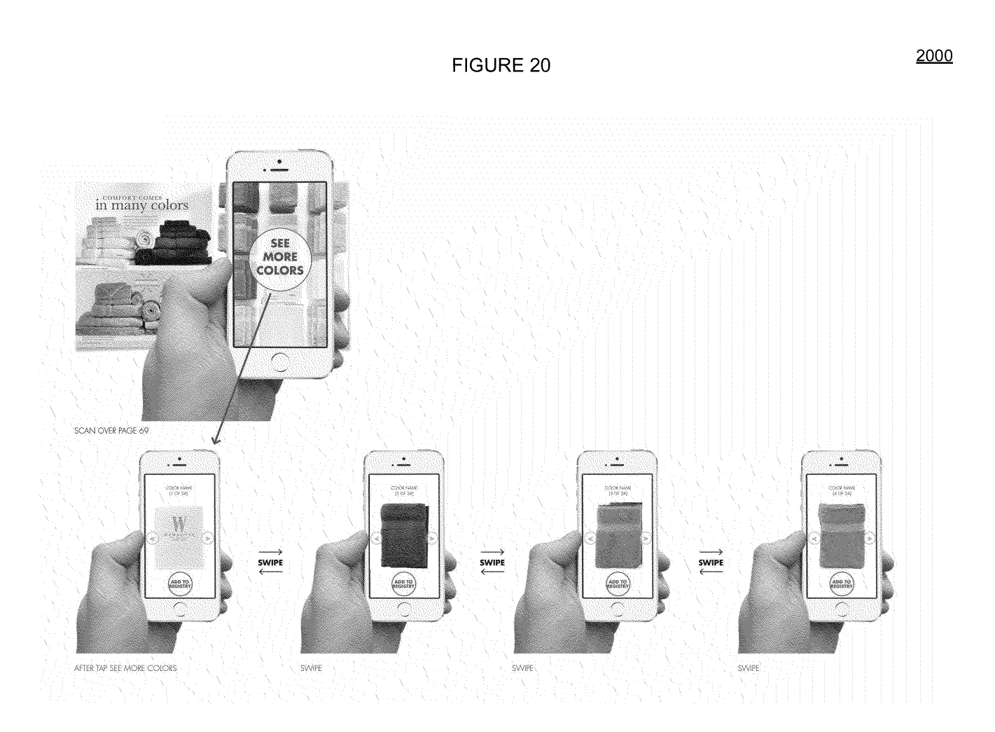

FIG. 20 is another example of an interactive session 2000 having features similar to interactive session 500 of FIG. 5. In this example, the interactive session 2000 includes a full page spread of a plurality of objects, such as towels, featured in the print media. The captured image includes only a portion of the print media, and when a given target item is tapped, a full page view of the target item, is displayed. This allows the user to interact with the interactive session 2000 using different kinds of actions, such as a swipe action on the display screen.

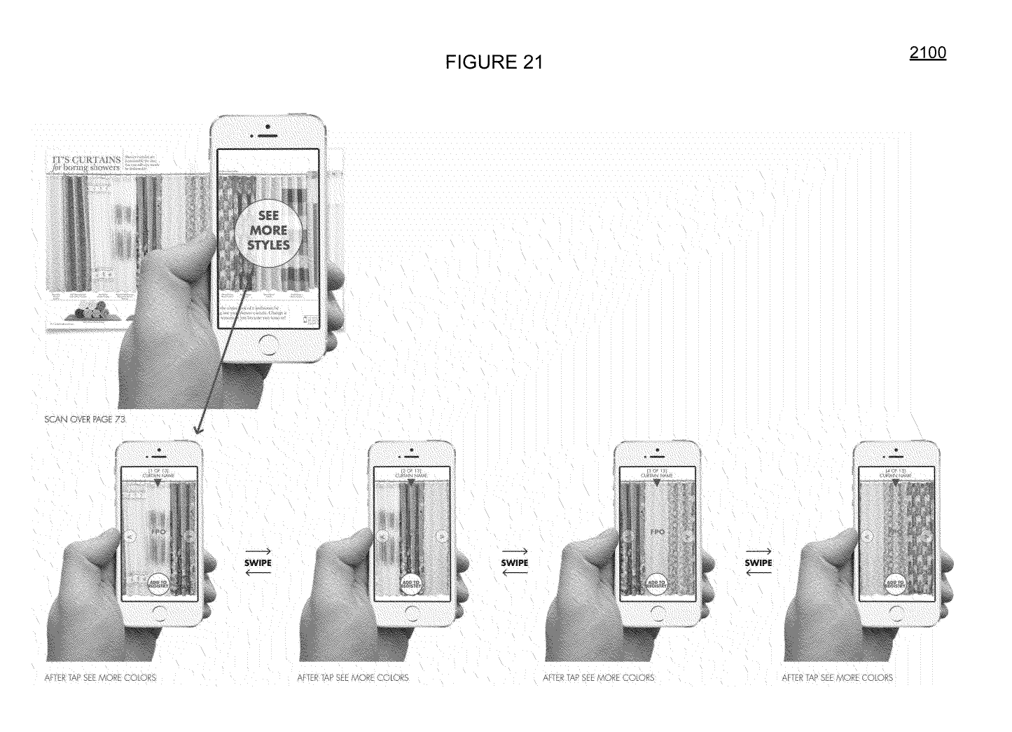

FIG. 21 is another example of an interactive session 2100 having features similar to interactive session 500 of FIG. 5. In this example, the interactive session 2100 includes a full page spread of a plurality of objects, such as shower curtains, featured in the print media. The captured image includes only a portion of the print media, and when a given target item is tapped, a full page view of the target item is displayed. This allows the user to interact with the interactive session 2100 using different kinds of actions, such as a swipe action on the display screen.

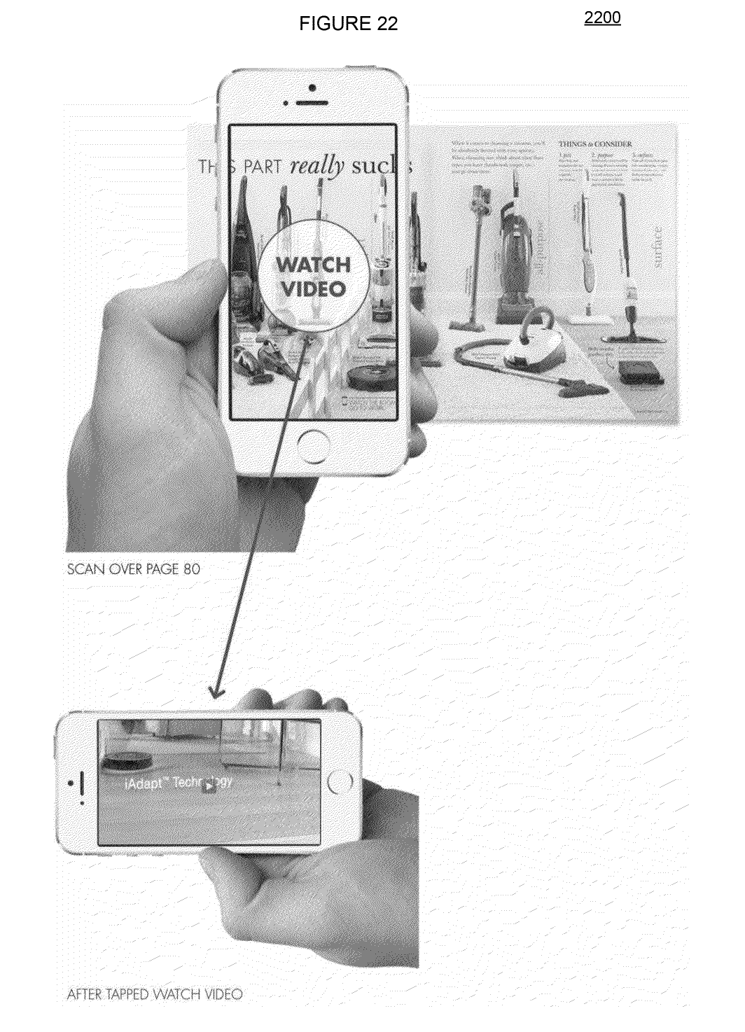

FIG. 22 is another example of an interactive session 2200 having features similar to interactive session 400 of FIG. 4. In this example, the interactive session 2200 includes additional multimedia data linked to the captured image of the target item.

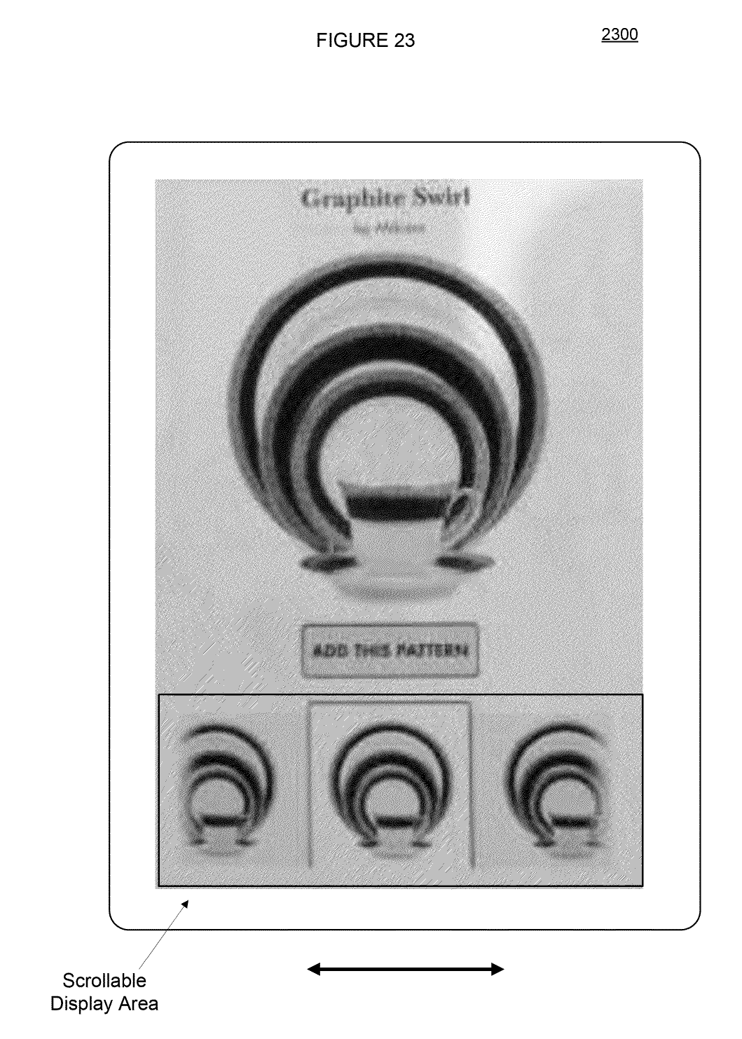

FIG. 23 is another example of an interactive session 2300 having features similar to interactive session 500 of FIG. 5. In this example, the interactive session 2300 includes a scrollable interactive page extension display area. The interactive page extension display area depicts a product carousel display where a user can rotate through additional styles, colors of an item, which are not included in the print media.

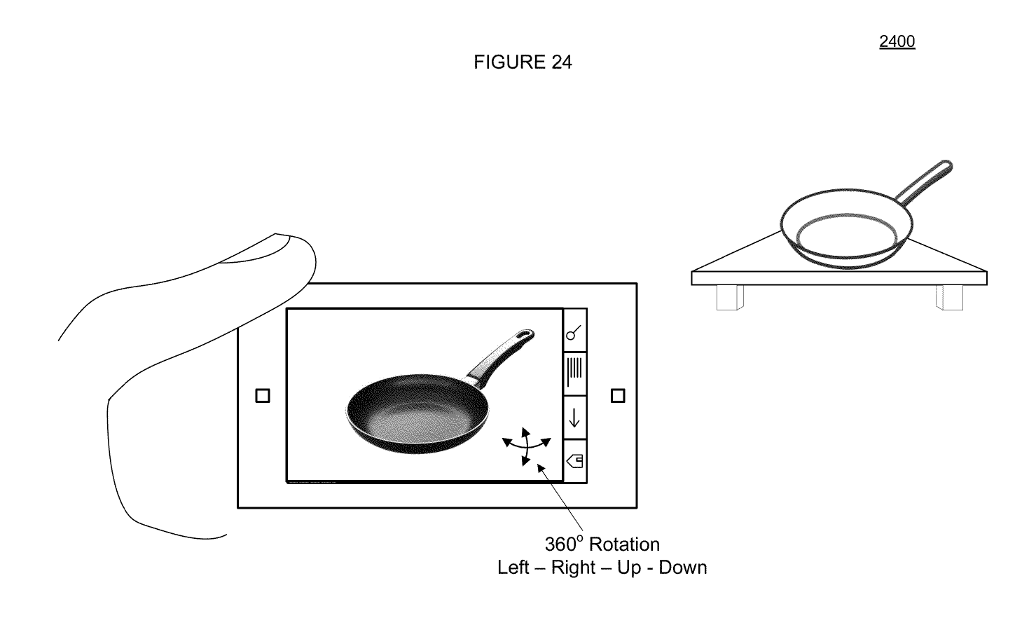

FIG. 24 is another example of an interactive session 2200 having features similar to interactive session 400 of FIG. 4. In this example, the interactive session 220 is linked to an object detected, by object recognition techniques, from a captured image of an actual, real world display of a sauce pan. This interactive session 220 allows the user to view a related 360 degree image of the pan from various angles, e.g., by operating controls associated with a device on which the related images are displayed, left, right, up and over, or down and under.

In a further embodiment, referring to FIGS. 9, 12, 15, 16, 17, 19, 21 and 22, the captured image or the related image may be displayed with indicia of a type of interactive session that may be performed by, for example, touching indicia on the display. In some embodiments, the indicia may indicate a type or characteristic of a related image(s). For example, the indicia may indicate display of multimedia data (e.g., video), various styles of the target item (e.g., “see more styles”), a 360 degree view, purchasing operations, or the like, as the interactive session.

The above-described aspects of the present disclosure may be advantageous for providing low cost improvements in techniques for interactively coupling electronic content with print media. This may allow producers of the print media to provide a user with an interactive experience with objects or portions of the print media without having to significantly alter a present form, shape or design of the printed content or the print media. Moreover, the various systems and methods disclosed within may be further reconfigured to increase the image processing speed used to generate and control the interactive sessions between the user and the electronic content.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. An image processing method performed at a wireless communication device, the method comprising:
receiving, using one or more processors, an image captured by the wireless communication device from print media;
detecting, using the one or more processors, an image of a target item from the captured image, the detected image corresponding to a portion of the captured image displayed at a display device associated with the wireless communication device;
preparing for display, using the one or more processors, a related image having a plurality of image portions retrieved from a database, the plurality of image portions being related to the detected image of the target item; and
providing, using the one or more processors, one or more controls associated with the display device, the one or more controls for receiving command information indicating at least part of the related image for an interactive session.

2. The method according to claim 1, wherein the related image includes image portions depicting a 3D image of the target item.

3. The method according to claim 1, wherein the interactive session includes simulating an operation of the target item.

4. The method according to claim 3, wherein the simulating an operation of the target item is operable by touching an area of the display device.

5. The method according to claim 1, wherein the related image includes image portions depicting a 360 degree view of the target item.

6. The method according to claim 5, wherein the interactive session includes rotating the 360 degree view of the target item between a first degree view and a second degree view.

7. The method according to claim 1, wherein the related image includes image portions depicting different versions of the target item for scrollable display.

8. The method according to claim 7, wherein the interactive session includes scrolling the images of the different versions of the target item to display a predetermined version of the target item.

9. The method according to claim 1, wherein the image is captured at a device having wireless communication capability and including the display device.

10. A non-transitory computer readable medium configured to store instructions that, when executed by one or more processors, cause the one or more processors to perform an image processing method at a wireless communication device, the method comprising:
receiving, using the one or more processors, an image captured by the wireless communication device from print media;
detecting, using the one or more processors, an image of a target item from the captured image, the detected image corresponding to a portion of the captured image displayed at a display device associated with the wireless communication device;
preparing for display, using the one or more processors, a related image having a plurality of image portions retrieved from a database, the plurality of image portions being related to the detected image of the target item; and
providing, using the one or more processors, one or more controls associated with the display device, the one or more controls for receiving command information indicating at least part of the related image for an interactive session.

11. The non-transitory computer readable medium according to claim 10, wherein the interactive session includes simulating an operation of the target item.

12. An image processing system of a wireless communication device, the system comprising:
a memory storing a plurality of images; and
one or more processors in communication with the memory, the one or more processors being configured to:
receive an image captured by the wireless communication device from print media;
detect an image of a target item from the captured image, the detected image corresponding to a portion of the captured image displayed at a display device associated with the wireless communication device;
prepare for display of a related image having a plurality of image portions retrieved from a database, the plurality of image portions being related to the detected image of the target item; and
provide one or more controls associated with the display device, the one or more controls being configured to receive command information indicating at least part of the related image for an interactive session.

13. The system according to claim 12, wherein the related image includes image portions depicting a 3D image of the target item.

14. The system according to claim 12, wherein the interactive session includes simulating an operation of the target item.

15. The system according to claim 14, wherein the simulating an operation of the target item is operable by touching an area of the display device.

16. The system according to claim 12, wherein the related image includes image portions depicting a 360 degree view of the target item.

17. The system according to claim 16, wherein the interactive session includes rotating the 360 degree view of the target item between a first degree view and a second degree view.

18. The system according to claim 12, wherein the related image includes image portions depicting different versions of the target item for scrollable display.

19. The system according to claim 18, wherein the interactive session includes scrolling the images of the different versions of the target item to display a predetermined version of the target item.

20. The system according to claim 12, wherein the image is captured at a device having wireless communication capability and including the display device.
